(19) United States
(12) Patent Application Publication
(10) Pub. No.: US 2026/0067628 A1
(43) Pub. Date: Mar. 5, 2026

(54) APPARATUS AND METHOD FOR RECOGNIZING A WATTAGE TAP SETTING OF AN AUDIO DEVICE

(71) Applicant: Siemens Schweiz AG, Zurich (CH)

(72) Inventors: Li Guo Chen, Beijing (CN); Hui Ming Chu, Beijing (CN); Jian Tan, Beijing (CN); Shao Chen Lin, Beijing (CN); Meng Yuan Tian, Beijing (CN)

(73) Assignee: Siemens Schweiz AG, Zurich (CH)

(21) Appl. No.: 19/296,310

(22) Filed: Aug. 11, 2025

(30) Foreign Application Priority Data
Aug. 28, 2024 (EP) 24197069.8

(51) Int. Cl. H04R 29/00; H04R 27/00

(52) U.S. Cl. CPC H04R 29/007; H04R 27/00

(57) ABSTRACT

Apparatus and methods recognize a wattage tap setting of an audio device.

The apparatus includes an audio load, wattage tap circuit, and controller. The wattage tap circuit has a particular wattage setting corresponding to an audio output level of the audio load. The controller sends a pulse signal to the wattage tap circuit and receives a return signal from the wattage tap circuit in response to the pulse signal.

The controller identifies the particular wattage setting of the wattage tap circuit based on the return signal.

### FIELD OF THE INVENTION

This application relates to the field of public message broadcasting systems and, more particularly, to a broadcasting system capable of recognizing a wattage tap setting of a public addressing speaker.

### BACKGROUND

Audio broadcasting systems are capable of communicating to occupants of a public area, such as a building, for public message broadcasting, such as emergencies or safety risks. Each public addressing speaker of the broadcasting system may include a set of power ratings, also referred to as wattage taps, to configure each speaker based on varying sizes of building space. For a conventional system, a power rating for each speaker may be set manually before being commissioned.

### SUMMARY

In accordance with one embodiment of the disclosure, there is provided an automatic recognition approach of a wattage tap setting for each audio appliance, such as a public addressing speaker, of a public message broadcasting system.

One aspect is an apparatus for recognizing a wattage tap setting of an audio device, the apparatus comprising an audio load, a wattage tap circuit, and a controller. The wattage tap circuit is coupled to the audio load, and the controller is coupled to the wattage tap circuit. The wattage tap circuit has a particular wattage setting of multiple wattage settings corresponding to an audio output level of the audio load.

The controller sends a pulse signal to the wattage tap circuit and receives a return signal from the wattage tap circuit in response to the pulse signal. The controller identifies the particular wattage setting of the wattage tap circuit based on the return signal.

Another aspect is a method for recognizing a wattage tap setting of an audio device. A pulse signal is sent from a controller to a wattage tap circuit. A return signal is received from the wattage tap circuit in response to the pulse signal. A particular wattage setting of multiple wattage settings of the wattage tap circuit is identified based on the return signal. The particular wattage setting corresponds to an audio output level of an audio load.

The above described features and advantages, as well as others, will become more readily apparent to those of ordinary skill in the art by reference to the following detailed description and accompanying drawings. While it would be desirable to provide one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects.

FIG. 1 is an exploded view of an audio device in an example implementation that is operable to employ techniques described herein.

FIG. 2 is a circuit diagram representing an electrical hardware portion of the audio device of FIG. 1 in an example implementation.

FIG. 3 is a graphical diagram representing voltage measurements of the primary winding of the transformer of FIG. 1 in an example implementation.

FIG. 4 is a block diagram representing the various components of the controller of FIG. 1 in an example implementation.

FIG. 5 is a flow diagram representing an operation of the audio device in an example implementation that is operable to employ techniques described herein.

### DETAILED DESCRIPTION

Various technologies that pertain to systems and methods that facilitate automatic recognition of a wattage tap setting for an audio appliance, such as a public addressing speaker of a public message broadcasting system, will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

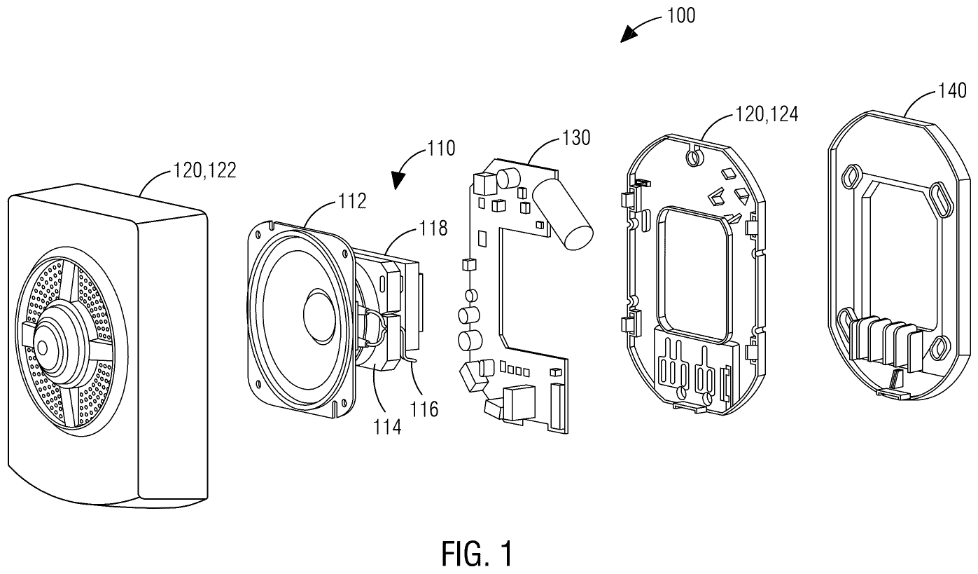

Referring to FIG. 1, there is shown an exploded view of an audio device 100 in an example implementation that is operable to employ techniques described herein. The audio device 100 includes an audio module 110, such as a speaker module, supported by and within a device housing 120. For example, the device housing 120 may include a front housing 122, such as a faceplate with an audio grill and an optical assembly, and a back housing 124, such as a circuit board cover. The audio module 110 may be supported in the housing 120 by, for example, positioning an audio output component 112, such as a speaker, of the audio module adjacent to the audio grill of the front housing 122. The audio device may also include a main circuit board 130, such as a PCBA, to manage power and general operation of the audio module 110 as well as one or more other components of the device, such as the optical assembly of the front housing 122. The audio device 100 may be mounted or placed on a structural surface. For some embodiments, the audio device 100 may include a mounting plate assembly 140 affixed to the structure surface so that the remainder of the audio device, particularly the rear housing 120, may be attached to and removed from the mounting plate assembly 140. It is to be understood that at least a portion of the audio module 110 may be exposed through the rear housing 120, the main circuit board 130, and/or the mounting plate assembly 140 for wired connections and/or accessibility by a technician.

An audio module 110 manages a wattage tap setting of the audio device 100. The audio module 110 includes the audio output component 112 and a module circuit board 114. The module circuit board 114 includes an audio connection capable of being coupled to the audio output component 112 for audio signaling and a signaling connection 116 capable of being coupled to the addressable system for addressable signaling. The audio module 110 may also include a transformer 118 to transfer electrical energy between module circuit board 114 and another circuit or power source external to the audio module 110.

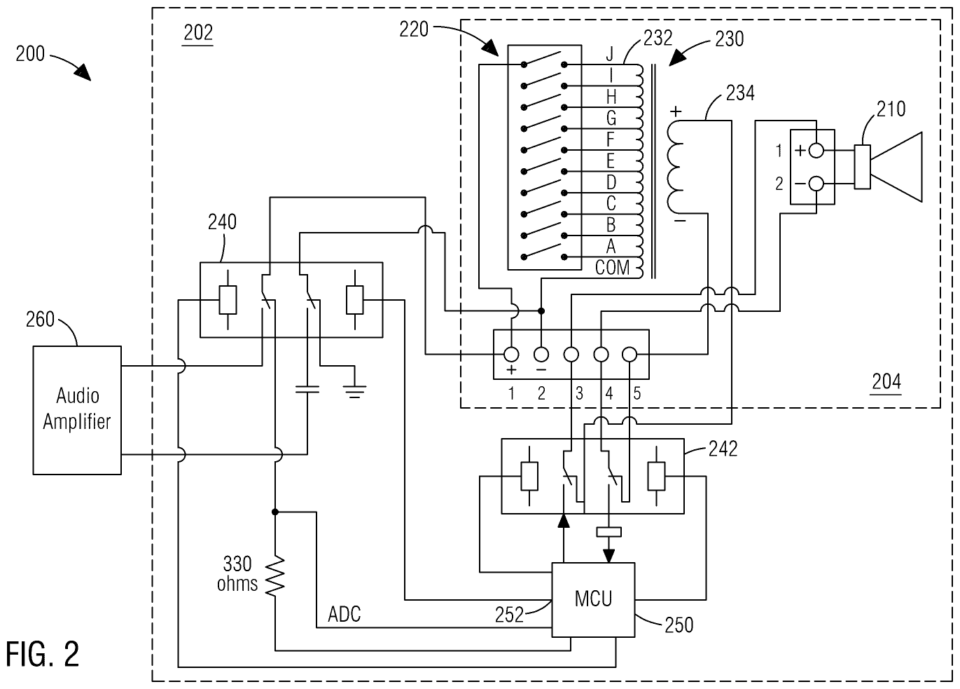

Referring to FIG. 2, there is shown a circuit diagram representing an apparatus 200 for recognizing a wattage tap setting of the audio device 100 in an example implementation. The apparatus 200 includes electrical components of the audio device 100. Although the apparatus 200 shown in FIG. 2 includes a main circuit board 202 and a transformer board 204, it is to be understood that various embodiments employing the techniques described herein may utilize multiple boards, a single board, or no boards. The apparatus 200 includes an audio load 210, such as a speaker, and a wattage tap circuit 220 coupled directly or indirectly to the audio load. For example, for some embodiments, the apparatus 200 may include a transformer 230, and the transformer may include a primary winding 232 and a secondary winding 234. To couple the wattage tap circuit 220 to the audio load 210, the wattage tap circuit is coupled to the primary winding 232 of the transformer 230 and the secondary winding 234 of the transformer is coupled to the audio load 210.

The wattage tap circuit 220 has multiple wattage settings corresponding to various, selectable audio output levels of the audio load 210. For some embodiments, the wattage tap circuit 220 may include a mechanical switch having multiple positions corresponding to the wattage settings. The mechanical switch may be moved from one position to another to control an electrical connection at each wattage setting based on a currently selected position. The current position is associated with a particular wattage setting corresponding to the audio output level of the audio load.

A relay circuit 240 and a controller 250 of the apparatus 200 may be coupled to the wattage tap circuit 220. For example, the relay circuit 240 may be coupled to the wattage tap circuit 220 and the controller 250, such as a microcontroller unit (“MCU”), may be coupled to the relay circuit. Regardless of whether the apparatus 200 includes the relay circuit 240, the controller 250 sends a pulse signal to the wattage tap circuit 220 and receives a return signal from the wattage tap circuit in response to the pulse signal. The controller 250 identifies the particular wattage setting of the wattage tap circuit 220 based on the return signal received from the wattage tap circuit 220. For some embodiments, the controller 250 sends the return signal (for example, data associated with the return signal) to an analog-to-digital converter port 252 of the controller 250.

The audio system includes one or more control panels to control public addressing speakers, such as audio load 210, to alert building occupants in case of public message broadcasting, emergencies, and safety risks. The audio system is distributed with long wires between speakers and amplifiers, such as audio amplifier 260. For a typical system driving voltages are stepped up and a transformer is provided at the speaker end. In particular, for each audio load, the system includes the audio amplifier 260 and a step-up transformer at one end of the long wires and the step-down transformer 230 and the audio load 210 at the other end. As shown in FIG. 2, signals originating from the audio amplifier 260 may feed to the relay circuit 240 and, from there, continue to the transformer 230 and the audio load 210. The apparatus 200 of the audio device 100 allows the system to read wattage tap settings of connected field devices. The system reviews wattage tap settings of the connected audio loads to determine whether the entire system is reasonable or not, i.e., whether the system can handle the wattage tap settings of all connected devices, i.e., whether the system load is appropriate as opposed to problematic.

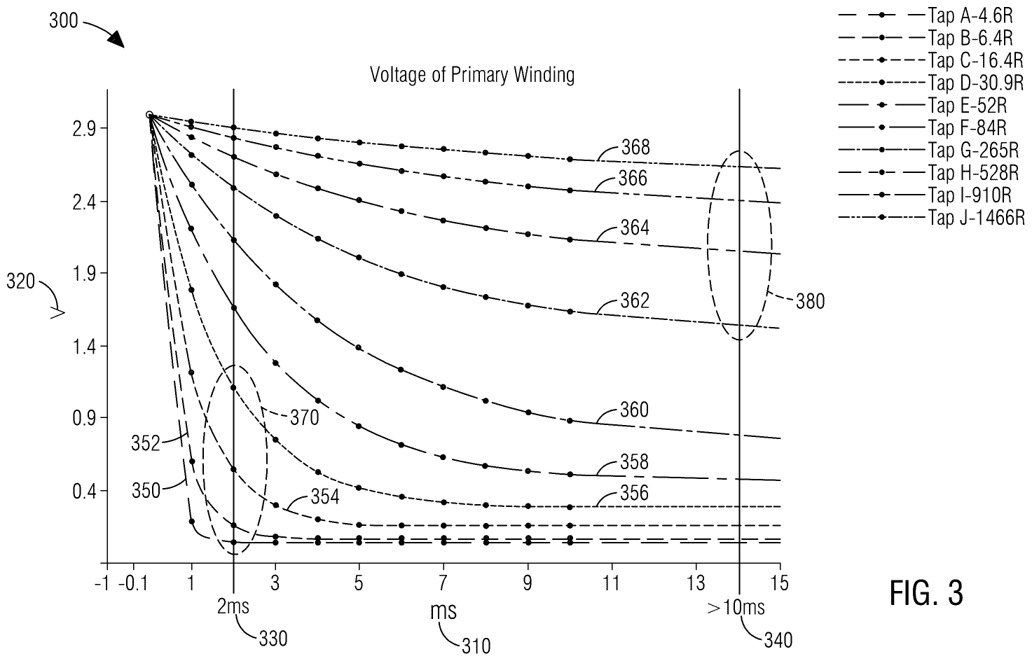

Referring to FIG. 3, there is shown a graphical diagram 300 representing voltage measurements of the primary winding 232 of the transformer 230 in an example implementation. For this diagram 300, the x-axis 310 represents the time in milliseconds (ms) of the pulse signal sent by the controller 250 from the starting point of the pulse signal, such as the time when the pulse signal initiated by the controller. The y-axis 320 represents the voltage of the primary winding 232 as indicated by the return signal received by the controller 250. The pulse signal sent by the controller 250 is greater than a null signal level, and the pulse signal is reset to the null signal level by the controller in response to receiving the return signal. The pulse signal is any type of power signal that is sustained for greater than ten (10) ms. For some embodiments, the pulse signal is a single pulse, and the return signal in response to the pulse signal includes multiple measurement points. For some embodiments, the pulse signal is a rectangular pulse signal, having a peak voltage of 3 volts, that is about 20 msec to 1 second in duration.

As depicted by FIG. 3, the controller 250 identifies the particular wattage setting of the wattage tap circuit 220 based on multiple measurement points of the return signal. The two measurements points of the return signal include a first point 330 subsequent to the starting point and a second point 340 subsequent to both the starting point and the first point. The starting point is time 0 msec and represents the generation time of pulse signal. For some embodiments, the first point 330 represents an inductance region of the primary winding 232 of the transformer 230 and the second point 340 represents a direct current resistance region of the primary winding of the transformer. For some embodiments, the first point 330 corresponds to a first voltage reading less than ten (10) msec from a starting point of the pulse signal and the second point 340 corresponds to a second voltage reading at least ten (10) msec from the starting point.

The diagram 300 depicts readings for the various wattage settings of the wattage tap circuit 220. The wattage settings include Tap A 350, Tap B 352, Tap C 354, Tap D 356, Tap E 358, Tap F 360, Tap G 362, Tap H 364, Tap I 366, and Tap J 368, where each Tap is associated with a particular wattage setting. For example, Tap A 350 may be associated with 8 watts, Tap B 352 may be associated with 4 watts, Tap C 354 may be associated with 2 watts, and so on all the way to the lowest tap, namely Tap J 368. For some embodiments, the first point 330 facilitates identification at higher wattage readings 370 more than the second point, and the second point 340 facilitating identification at lower wattage readings 380 more than the first point. At least one wattage reading may be determined by the control circuit, specifically the controller 250, based on the first and second points 330, 340 of the return signal. The controller 250 identifies the particular wattage setting of the wattage tap circuit 220 by correlating the measurement points 330, 340 with predetermined characteristics of the wattage settings. The wattage setting have characteristics that most closely resembles the measurement points 330, 340 is determined by the controller 250 to be the recognized setting.

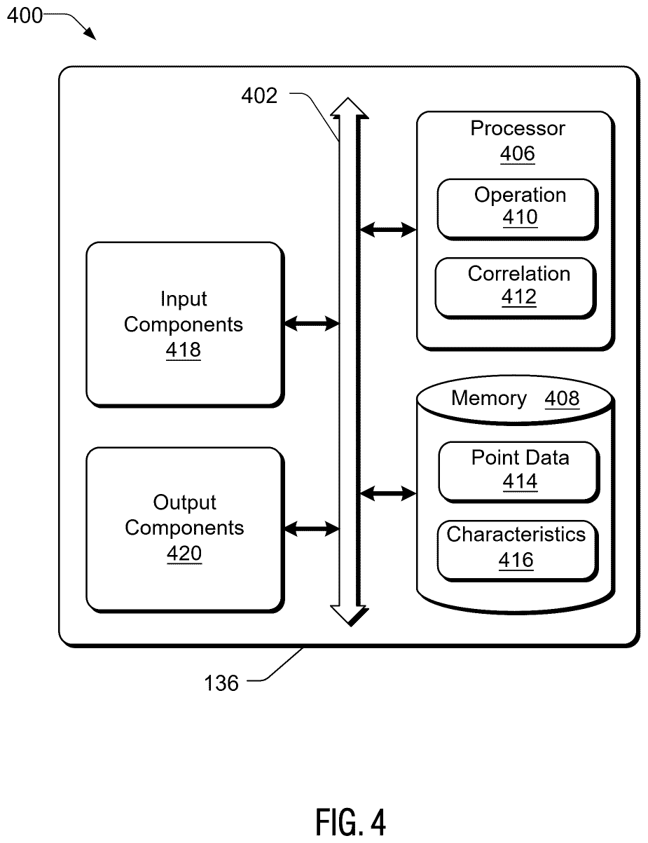

Referring to FIG. 4, there are shown system components 400 of a controller 250 in an example implementation. The system components 400 comprise one or more communication lines 402 for interconnecting other system components directly or indirectly. The other system components include one or more processors 406 and one or more memory components 408. The processor or processors 406 may send data to, and process commands received from, other components of the system components, such as information of the memory component 408. Each application includes executable code to provide specific functionality for the processor 406 and/or remaining components of the controller 250.

Examples of applications executable by the processor 406 include, but are not limited to, an operation module 410 and a correlation module 412. The operations module 410 may perform general operations to manage the controller 250, such as communications with other devices and audio output at the audio output component 112 or audio load 210. The correlation submodule 412 may manage signaling between the controller 250 and the wattage tap circuit 220 as well as identify the particular wattage setting of the wattage tap circuit based on the return signal received by the controller.

Data stored at the memory component 408 is information that may be referenced and/or manipulated by a module of the processor 406 for performing functions of the controller 250. Examples of data associated with the controller 250 and stored by the memory component 408 may include, but are not limited to, point data 414 and characteristics data 416. The point data 414 includes measurements of the return signal in response to pulse signals. The characteristics data 416 include data representing voltage characteristics of the primary winding for all wattage settings of the controller 250 of the audio device 100.

The system components 400 may include input components 418 and output components 420 that manages one or more input components and/or an output component. The input components and the output components 418, 420 of the system components may also include one or more communication, signaling, visual, audio, mechanical, or other components that receive and/or provide information with an entity external to the controller 250. For example, an input component 418 may receive signals from the wattage tap circuit 220 and an output component 420 may send signals to the wattage tap circuit. The signals may traverse through other components, such as the relay circuit 240, and similar signaling may be managed for other components of the apparatus 200, such as another relay circuit 242.

It is to be understood that FIG. 4 is provided for illustrative purposes only to represent an example implementation of the controller 250 and is not intended to be a complete diagram of the various components that may be utilized by the device. The controller 250, may include various other components not shown in FIG. 4, may include a combination of two or more components, or a division of a particular component into two or more separate components, and still be within the scope of the present invention. Also, the system components 400 may be coupled directly or indirectly to each other to perform the operations of the controller 250. For example, the processor 406 may be coupled, directly or indirectly, to the input/output components 418, 420.

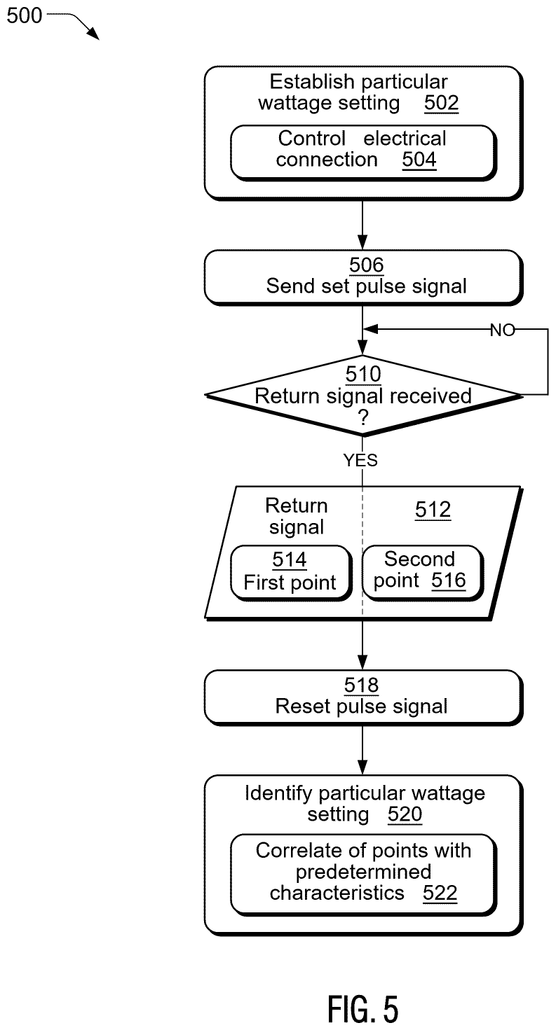

Referring to FIG. 5, there is shown a flow diagram representing an operation 500 of the audio device in an example implementation. The example operation 500 depicts a method for recognizing a wattage tap setting of an audio device. The operation 500 establishes (502) a particular wattage setting of the multiple wattage settings of the wattage tap circuit 220. For some embodiments, the operation 500 controls (504) an electrical connection at the specific wattage setting based on a current position of a mechanical switch. The current position may be selected among multiple positions corresponding to the wattage settings.

Subsequent to establishing (502) the particular wattage setting, the operation 500 sends (506) a pulse signal from the controller 250 to the wattage tap circuit 220. In response to sending (506) the pulse signal, the controller 250 awaits (510) a response from the wattage tap circuit 220. Subsequent to sending (506) the pulse signal, the controller 250 receives (510) a return signal 512 from the wattage tap circuit 220 in response to the pulse signal. For some embodiments, the return signal 512 is an analog signal so the return signal, or data associated with it, is directed to an analog-to-digital converter port of the controller 250. For some embodiments, the pulse signal that is greater than a null signal level. For some embodiments, the pulse signal is a single pulse, and the return signal 512, in response to the pulse signal, includes multiple measurement points.

The particular wattage setting is identified based on the measurement points. The measurement points of the return signal 512 includes first and second points 514, 516. For some embodiments, the first point 514 facilitates identification at higher wattage readings more than the second point 516, and the second point facilitates identification at lower wattage readings more than the first point. For some embodiments, the first point 514 represents an inductance region of the primary winding 232 of the transformer 230 and the second point 516 represents a direct current resistance region of the primary winding of the transformer. For some embodiments, the first point 514 corresponds to a first voltage reading less than ten (10) msec from the starting point of the pulse signal and the second point corresponds to a second voltage reading at least ten (10) msec from the starting point.

In response to receiving (510) the return signal 512 or data associated with the return signal, the controller 250 resets (518) the pulse signal the null signal level and identifies (520) a particular wattage setting of the wattage tap circuit 220 based on the return signal received by the controller. The controller 250 may resets (518) the pulse signal before, after, or concurrently while identifying (520) the particular wattage setting. The particular wattage setting corresponds to the audio output level set for the audio load. For some embodiments, the controller 250 correlates (522) the measurement points with predetermined characteristics of the wattage settings.

Those skilled in the art will recognize that, for simplicity and clarity, the full structure and operation of all data processing systems suitable for use with the present disclosure are not being depicted or described herein. Also, none of the various features or processes described herein should be considered essential to any or all embodiments, except as described herein. Various features may be omitted or duplicated in various embodiments. Various processes described may be omitted, repeated, performed sequentially, concurrently, or in a different order. Various features and processes described herein can be combined in still other embodiments as may be described in the claims.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution.

Examples of machine usable/readable or computer usable/readable mediums include nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an example embodiment of the present disclosure has been described in detail, those skilled in the art will understand that various changes, substitutions, variations, and improvements disclosed herein may be made without departing from the spirit and scope of the disclosure in its broadest form.

What is claimed is:

1. An apparatus for recognizing a wattage tap setting of an audio device, the apparatus comprising:
an audio load;
a wattage tap circuit coupled to the audio load, the wattage tap circuit having a particular wattage setting of a plurality of wattage settings corresponding to an audio output level of the audio load; and
a controller coupled to the wattage tap circuit, the controller sending a pulse signal to the wattage tap circuit, receiving a return signal from the wattage tap circuit in response to the pulse signal, and identifying the particular wattage setting of the wattage tap circuit based on the return signal received from the wattage tap circuit.

2. The apparatus as described in claim 1, further comprising a transformer including a primary winding and a secondary winding, wherein the wattage tap circuit is coupled to the audio load by the wattage tap circuit being coupled to the primary winding and the secondary winding being coupled to the audio load.

3. The apparatus as described in claim 1, wherein the pulse signal sent by the controller is greater than a null signal level, and the pulse signal is reset to the null signal level by the controller in response to receiving the return signal.

4. The apparatus as described in claim 1, wherein:
the pulse signal is a single pulse;
the return signal in response to the pulse signal includes a plurality of measurement points; and
the controller identifies the particular wattage setting of the wattage tap circuit based on the plurality of measurement points.

5. The apparatus as described in claim 4, wherein the plurality of measurement points of the return signal includes first and second points, the first point facilitating identification at higher wattage readings more than the second point, and the second point facilitating identification at lower wattage readings more than the first point.

6. The apparatus as described in claim 4, wherein the plurality of measurement points of the return signal includes a first point representing an inductance region of a primary winding of a transformer and a second point representing a direct current resistance region of the primary winding of the transformer.

7. The apparatus as described in claim 4, wherein the plurality of measurement points include a first point corresponds to a first voltage reading less than ten msec from a starting point of the pulse signal and a second point corresponds to a second voltage reading at least ten msec from the starting point.

8. The apparatus as described in claim 4, wherein the controller identifies the particular wattage setting of the wattage tap circuit by correlating the plurality of measurement points with predetermined characteristics of the plurality of wattage settings.

9. A method for recognizing a wattage tap setting of an audio device, the method comprising:
sending a pulse signal from a controller to a wattage tap circuit;
receiving a return signal from the wattage tap circuit in response to the pulse signal, and
identifying, by the controller, a particular wattage setting of a plurality of wattage settings of the wattage tap circuit based on the return signal, the particular wattage setting corresponding to an audio output level of an audio load.

10. The method as described in claim 9, wherein:
sending the pulse signal by the controller includes sending the pulse signal that is greater than a null signal level; and
receiving the return signal includes resetting the pulse signal to the null signal level in response to receiving the return signal.

11. The method as described in claim 9, wherein:
the pulse signal is a single pulse;
the return signal in response to the pulse signal includes a plurality of measurement points; and
identifying the particular wattage setting includes identifying the particular wattage setting based on the plurality of measurement points.

12. The method as described in claim 11, wherein the plurality of measurement points of the return signal includes first and second points, the first point facilitating identification at higher wattage readings more than the second point, and the second point facilitating identification at lower wattage readings more than the first point.

13. The method as described in claim 11, wherein the plurality of measurement points of the return signal includes a first point representing an inductance region of a primary winding of a transformer and a second point representing a direct current resistance region of the primary winding of the transformer.

14. The method as described in claim 11, wherein the plurality of measurement points of the return signal includes a first point corresponding to a first voltage reading less than ten msec from a starting point of the pulse signal and a second point corresponding to a second voltage reading at least ten msec from the starting point.

15. The method as described in claim 11, wherein identifying the particular wattage setting includes correlating the plurality of measurement points with predetermined characteristics of the plurality of wattage settings.
